(19) United States
(12) Patent Application Publication
(10) Pub. No.: US 2007/0097408 A1
(43) Pub. Date: May 3, 2007

(54) Image forming device

(76) Inventor: Makoto Ohkado, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,883

(22) Filed: Oct. 27, 2005

(51) Int. Cl. G06K 15/00

(52) U.S. Cl. 358/1.14

(57) ABSTRACT

When there is a change in the content of a setting related to a function of an image forming device, including function parameters and system specifications, the information to be displayed on a liquid crystal display unit is determined according to the type of the change in the setting. A counter then counts the number of times each user uses the image forming device after information is selected for display on the liquid crystal display unit. When any particular user uses the image forming device, the information is displayed on the liquid crystal display unit (step T6) only if the value of the counter for that user (the number of times that user used the image forming device after information was selected for display) is 0 (step T4 returns Yes).

### FIELD OF THE INVENTION

The present invention relates to an image forming device such as a photocopier.

### BACKGROUND INFORMATION

If the user is not informed of changes that have occurred in the printing environment, such as when the content of a setting relating to a particular function of the image forming device is changed (for example, when the parameter content of a particular function is changed, such as changing the type of paper stored in the paper cassette, or when the system configuration is changed, such as modifying the software to enable printing on postcards), the user will likely start printing without knowing that the printing environment had changed. This results in such problems as being unable to print the desired output or being unable to use convenient features that were made usable as a result of the change in the printer configuration.

Conventional systems that can report the content of changes in the printing environment to the user are known from the literature.

If predetermined information must be reported to the user, such as when the printing environment changes as described above, and this information is output repeatedly over and over, the same information will be reported to the same user multiple times. This can become irritating. On the other hand, if this predetermined information is reported for only a specific period of time and a particular user does not use the image forming device during this reporting period, the information will in effect not be reported to the user and the user will therefore proceed to print without being aware of the change in the printing environment.

The present invention is directed to these problems, and an object of the invention is to provide an image forming device that reports predetermined information to each user only a predetermined number of times.

### SUMMARY OF THE INVENTION

To achieve this object, the invention described in claim 1 has a display unit (72); a display decision means (40, S2) for deciding whether to display predetermined information on the display unit; an identification means (40, T2) for identifying a user based on an input signal; a counting means (46) for counting as an identification count how many times each user is identified by the identification means after the display decision means decides to display the predetermined information on the display unit; an identification count reading means (40, T3) for reading the identification count maintained by the counting means for the user identified by the identification means when the identification means identifies a user; and a display means (40, T6) for displaying the predetermined information on the display unit only when the identification count read by the identification count reading means is less than a predetermined count.

Note that the reference numerals and letters contained in parentheses here and below denote the corresponding elements in the embodiment described below.

Thus comprised, the counting means keeps an identification count denoting how many times each user is identified by the identification means, that is, how many times each user uses this image forming device, after it is determined that predetermined information is to be presented on the display unit. When a certain user then uses this image forming device, the predetermined information is displayed on the display unit only if the identification count (the number of times the user used the image forming device after it was decided to display predetermined information) for that user is less than the predetermined count. The predetermined information is therefore reported only the predetermined number of times to every person using the image forming device.

As described in claim 2, the predetermined information can be information indicating that a setting related to a function of the image forming device changed.

The invention described in claim 3 is the image forming device described in claim 1 further comprising a means (40) for changing the predetermined count according to the predetermined information type.

The invention thus comprised can increase this predetermined count if the information to be reported is important information that should be presented to the user multiple times, and decrease the predetermined count if the information to be reported is not particularly important. Information can therefore be reported an appropriate number of times according to the type of information to be reported.

### BRIEF DESCRIPTION OF THE DRAWINGS

FIG. 1 is a block diagram describing the electrical arrangement of an image forming device according to a preferred embodiment of the invention.

FIG. 2 is a plan view showing the arrangement of the operating panel.

FIG. 3 is a flow chart describing the control process performed by the control unit when a parameter is changed for a particular function of the image forming device.

FIG. 4 is a flow chart describing the control process performed by the control unit when an identification number is entered by the user.

FIG. 5 shows an example of an announcement displayed on the LCD unit.

### DETAILED DESCRIPTION OF THE PREFERRED EMBODIMENTS

A preferred embodiment of the present invention is described below with reference to the accompanying figures.

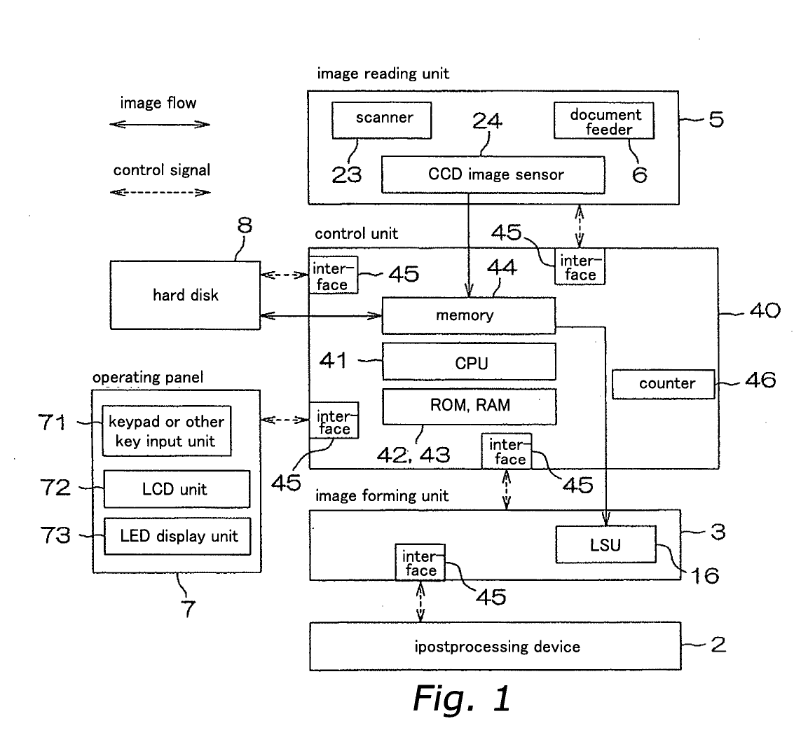

FIG. 1 is a block diagram describing the electrical arrangement of an image forming device according to a preferred embodiment of the invention.

Referring to FIG. 1, an image forming device according to this embodiment of the invention is, for example, a digital color photocopier that can form color images based on image data on the paper that is being used. This image forming device has a control unit 40 for controlling the operation of this image forming device. Connected either directly or indirectly to this control unit 40 through an interface (I/F) 45 are an image reading unit 5 for scanning an image of the original document, a hard disk (HDD) 8 for compressing and storing the scanned image data, an image forming unit 3 for forming (printing) a color image on paper based on the scanned image data, a postprocessing device 2 for applying a predetermined finishing operation to the paper after image formation, and an operating panel 7 for setting the operating content (such as function parameters) of the image forming device. The control unit 40 is a microcomputer, for example, including a CPU 41, ROM 42, RAM 43, and memory 44 for storing image data.

An arrangement known from the literature having a scanner 23 for emitting light to the original document can be used as the image reading unit 5. Image data representing the original document is acquired by a CCD image sensor 24 detecting the reflection of light emitted from the scanner 23 onto the original document and then converting the detected light to an electric signal. The image data for the original document scanned by the image reading unit 5 is sent from the CCD image sensor 24 to the control unit 40 and then stored in memory 44 after applying predetermined image processing.

The image reading unit 5 in this embodiment of the invention has an automatic document feeder (DF) 6 for automatically supplying one or a plurality of original documents set on the original document tray (not shown in the figure) to the scanner 23 for scanning (for continuous scanning). A mechanism for automatically reversing the original documents supplied from the original document tray to the scanner 23 is also disposed to the automatic document feeder 6 so that the original document can be scanned on only one side to capture image data for a single side or the original document can be scanned on both sides to capture image data for both sides of the original document.

An arrangement known from the literature having a photoconductor, main charger, developing device, transfer device, and laser scanning unit (LSU) 16 can be used for the image forming unit 3. More specifically, during the image forming process the surface of a substantially cylindrical photoconductor is uniformly charged by the main charger, and the laser scanning unit 16 exposes the surface of the photoconductor to light based on the image data to form a so-called electrostatic latent image on the surface of the photoconductor. The developing device then selectively deposits cyan, magenta, yellow, and black monochrome toners on the surface of the photoconductor on which the electrostatic latent image was formed, thus producing a toner image. This toner image formed on the surface of the photoconductor is then transferred to paper by the work of the transfer device. A duplex mechanism for reversing the paper is disposed to the image forming unit 3 so that an image can be formed on only one side of the paper or an image can be formed on each side of the paper.

The paper that is used for image forming is loaded in a plurality of paper cassettes located inside the image forming device or in a manual paper tray located on the side of the image forming device. This image forming device can use paper of different sizes (such as A4 and B5 paper sizes defined in the Japan Industrial Standard (JIS)) and type (such as plain paper for monochrome printing, or color paper for color printing).

In addition to a key input unit 71 such as a keypad with buttons that can be pressed, the operating panel 7 includes, for example, a liquid crystal display (LCD) unit 72 and an LED display unit 73.

The postprocessing device 2 is for applying finishing processes such as a punching process to punch holes at predetermined positions in the paper after image formation, a stapling process to bind a plurality of sheets together with a staple after image formation, a binding process to bind a plurality of sheets together after image formation, and a sorting process to separate the copied sheets of a multipage document into collated units after image formation.

The control unit 40 manages user information, such as a history of the user's past copy operations (the number of copies made, for example), for each user. To use this image forming device, the user uses the operating panel 7 to enter the identification number assigned to the user, and the control unit 40 identifies the user based on the entered identification number. The control unit 40 has a counter 46 that counts the number of times each user is identified by the control unit 40, that is, counts the number of times each user uses the image forming device.

User identification is not limited to entering an identification number assigned to each user as described above, however. More particularly, users can be identified by using an identification number reading means disposed to the image forming device to read the identification number stored in an identification number storage medium (such as an ID card) assigned to each user, or a means for reading biometric data (such as a fingerprint, voice print, or retina print) from the user can be disposed to the image forming device so that the user can be identified from biometric data.

The user can also use the operating panel 7 in this image forming device to change various function settings, including, for example, changing the type of paper stored in a paper cassette. A service technician can also change the system specifications to, for example, enable printing on postcards by changing the firmware stored in ROM 42 in control unit 40. When the parameter settings of a particular function in this image forming device are thus changed (by changing a function setting or the system specifications, for example), the control unit 40 presents information to that effect (an announcement) on the LCD unit 72 so that the user can be made aware of the change in the printing environment. This can prevent situations such as being unable to print as desired or being unable to use convenient functions that have been rendered usable by a change in system specifications.

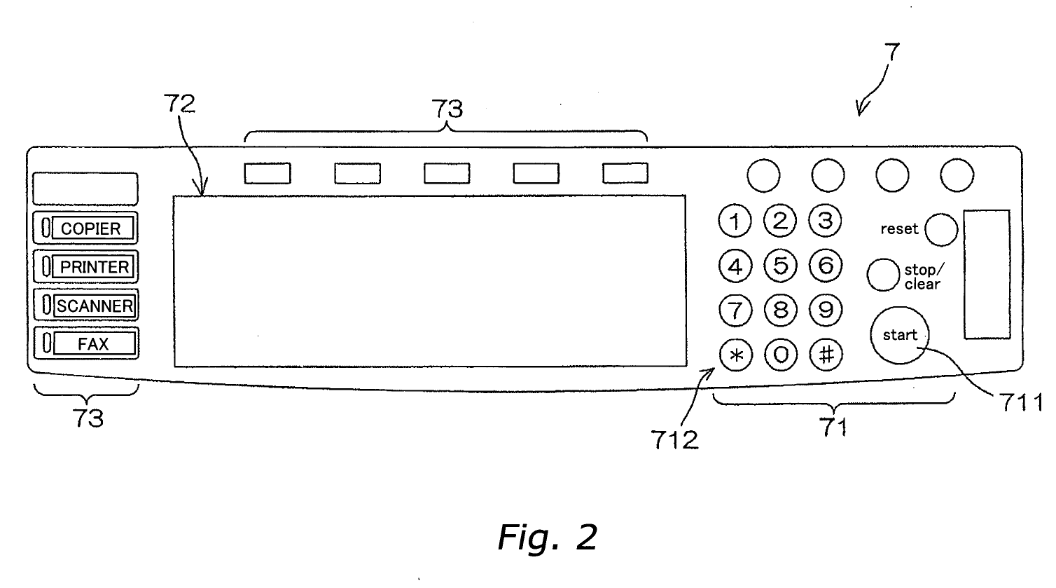

FIG. 2 is a plan view showing the arrangement of the operating panel 7.

Referring to FIG. 2, the LCD unit 72 is located substantially in the middle of the operating panel 7, for example. The LCD unit 72 is a liquid crystal display device with a touch panel, thus enabling the user to configure the functions of the image forming device by touching keys presented on the display screen.

The key input unit 71 is disposed beside the LCD unit 72, for example, and includes a keypad 712 that is used to set the number of copies, and a start key 711 that is pressed to start the image forming operation.

When the user presses buttons or keys in the key input unit 71 or LCD unit 72, input signals corresponding to the operation are applied to the control unit 40. The content displayed on the LCD unit 72 and the on/off states of the LED display unit 73 located beside the LCD unit 72 are controlled by output signals from the control unit 40 to display the operating status of the image forming device and the function settings.

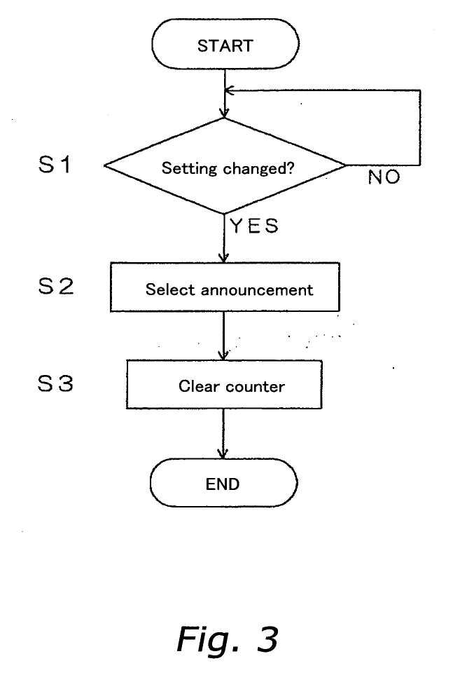

FIG. 3 is a flow chart showing the control process performed by the control unit 40 when the setting of a function of the image forming device is changed.

Referring to FIG. 3, when a setting relating to a function of the image forming device changes (including the value of a function parameter or the content of the system specifications) (step S1 returns Yes), the control unit 40 determines the announcement to be presented on the LCD unit 72 according to the type of change in the setting (step S2). Various announcements corresponding to the type of change in the setting of a function of the image forming device are previously stored in the ROM 42 of the control unit 40, and the control unit 40 can determine the announcement that will be presented on the LCD unit 72 by reading the announcement corresponding to the type of change in the setting from ROM 42.

The control unit 40 then clears the counter 46 (step S3) to start the identification count indicating how many times the identification number entered by each user is identified by the control unit 40, that is, the count indicating the number of times each user has used the image forming device, from 0.

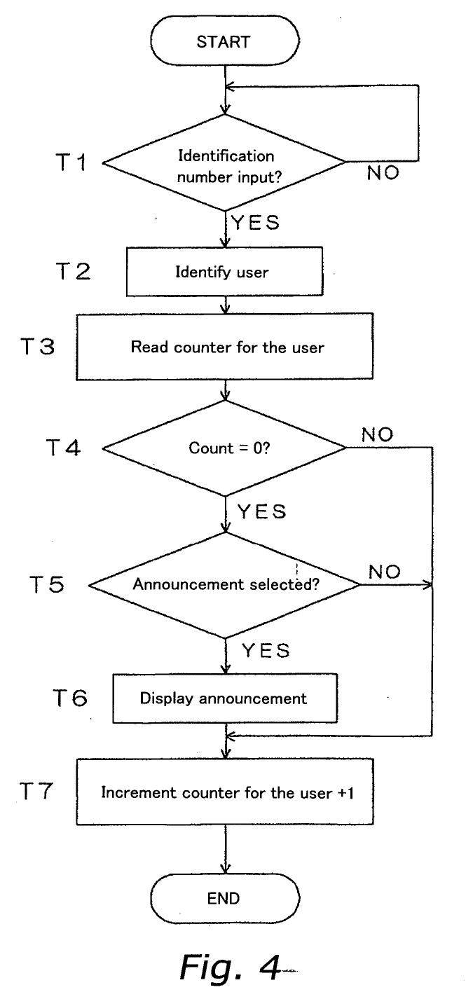

FIG. 4 is a flow chart describing the control process performed by the control unit 40 when a user enters an identification number.

Referring to FIG. 4, when a user operates the operating panel 7 and enters the identification number assigned to that user (step T1 returns Yes), the control unit 40 identifies the user from the entered identification number (step T2) and reads the value of the counter 46 for that user (step T3).

If the value of the counter 46 for that user is 0 (step T4 returns Yes) and the announcement to be presented on the LCD unit 72 has been determined (in step S2 in FIG. 3) (step T5 returns Yes), the control unit 40 presents the selected announcement on the LCD unit 72 (step T6) and then increments the count of the counter 46 for that user by 1 (step T7).

However, if the count of the counter 46 is not 0 (step T4 returns No), or if the announcement to be presented on the LCD unit 72 has not been decided (in step S2 in FIG. 3) (step T5 returns No), the control unit 40 increments the count of the counter 46 corresponding to that user by 1 without displaying the announcement on the LCD unit 72.

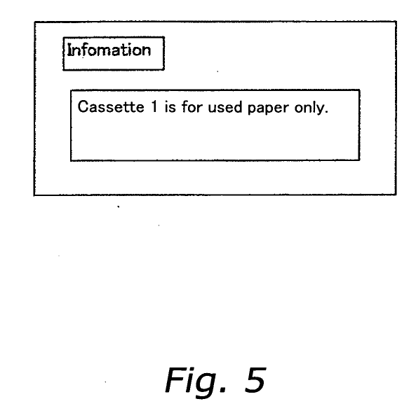

FIG. 5 shows an example of an announcement displayed on the LCD unit 72.

If, for example, the user has always used only new paper for printing, but then decides to use used paper (paper that has been printed on one side) and print on the unused side of the paper in order to reduce expenses, the user can use the operating panel 7 to change the type of paper stored in one of the multiple paper cassettes (cassette 1 in this example) from new paper to used paper. This causes the control unit 40 to read the corresponding announcement saying “Cassette 1 is for used paper only” that is stored in ROM 42 for this type of change in the settings, and thus determine the announcement to be displayed on the LCD unit 72, in step S2 in FIG. 2 [sic, FIG. 3].

When the announcement is then displayed in step T6 in FIG. 3 [sic, FIG. 4], the announcement is displayed on the LCD unit 72 as shown in FIG. 4 [sic, FIG. 5] by way of example. The announcement displayed in the LCD unit 72 is then erased from the display screen of the LCD unit 72 in response to the user subsequently using the operating panel 7. The announcement can be displayed using the entire display area of the LCD unit 72 as shown in FIG. 4 [sic, FIG. 5], or using only a part of the display screen in the LCD unit 72.

In another example, the system specifications initially do not allow printing on postcards, but the service technician then changes the system configuration by modifying the firmware stored in ROM 42 as requested by the user to enable printing on postcards placed on the manual insertion tray. This causes the control unit 40 to read the corresponding announcement saying “Copying on postcards using the bypass (manual insertion) tray is now possible” that is stored in ROM 42 for this type of change in specifications, and thus determine the announcement to be displayed on the LCD unit 72, in step S2 in FIG. 2 [sic, FIG. 3].

The identification count denoting the number of times each user is identified by the control unit 40, that is, the number of times each user uses this image forming device, after an announcement is selected for presentation on the LCD unit 72 can be counted by the counter 46 in this embodiment of the invention. When a certain user then uses this image forming device, the announcement is displayed on the LCD unit 72 only if the identification count for that user (the number of times the user has used the image forming device after it is decided to display an announcement) is less than a predetermined count (such as less than 1). The announcement is thus displayed only the predetermined number of times (such as once) for every user.

This embodiment of the invention is described as displaying an announcement only once for each user, but the invention will not be so limited. For example, when the setting for a particular function of this image forming device is changed (including changing the content of a function parameter or changing the content of the system specifications), the control unit 40 can also change this predetermined number of times the announcement is displayed according to the type of content changed (the type of announcement).

This enables increasing this predetermined display count if the announcement that is displayed contains important information that should be presented to the user multiple times, and decreasing the predetermined display count if the announcement to be displayed is not particularly important. Announcements can therefore be presented an appropriate number of times according to the type of announcement to be presented.

The present invention is not limited to the content of the embodiment described above, and can be varied in many ways without departing from the scope of the accompanying claims.

If, for example, the content of one function of the image forming device is changed (including changing the content of a function parameter or changing the content of the system specifications), the counter 46 is cleared in step S3 in FIG. 3, and then the content of another function is also changed before a user is identified by the control unit 40 (that is, before a user uses the image forming device), a plurality of announcements will be selected for presentation to the user. In this situation, all of the announcements selected during this period for presentation can be displayed when the announcement is displayed in step T6 in FIG. 4 after a user is then identified by the control unit 40 (that is, when a user uses the image forming device).

Announcements that were previously displayed on the LCD unit 72 could also recalled using the operating panel 7 and displayed on the LCD unit 72 again.

This embodiment of the invention is described as determining the announcement to be displayed on the LCD unit 72 by reading announcement information stored in ROM 42 according to the type of change in the settings relating to the functions of the image forming device (including changing the content of a function parameter or changing the content of the system specifications), but the invention is not limited to this arrangement. More particularly, the announcement to be displayed on the LCD unit 72 could be determined by using the operating panel 7 or by using a personal computer connected to the image forming device over a network.

The display unit is also not limited to a display unit rendered in unison with an operating unit, such as the LCD unit 72 consisting of a liquid crystal display device with an integral touch panel. More particularly, the operating unit and display unit can be separate devices.

The present invention is also not limited to use in a digital color photocopier, and can be applied to a digital monochrome photocopier or an analog photocopier, as well as image forming devices other than photocopiers, including printers and facsimile machines.

What is claimed is:

1. An image forming device comprising:
a display unit;
a display decision means for deciding whether to display predetermined information on the display unit;
an identification means for identifying a user based on an input signal;
a counting means for counting as an identification count how many times each user is identified by the identification means after the display decision means decides to display the predetermined information on the display unit;
an identification count reading means for reading the identification count maintained by the counting means for the user identified by the identification means when the identification means identifies a user; and
a display means for displaying the predetermined information on the display unit only when the identification count read by the identification count reading means is less than a predetermined count.

2. The image forming device according to claim 1, wherein the predetermined information is information indicating that a setting related to a function of the image forming device changed.

3. The image forming device according to claim 1, further comprising a means for changing the predetermined count according to the predetermined information type.
